(19) United States
(12) Patent Application Publication
(10) Pub. No.: US 2016/0346066 A1
(43) Pub. Date: Dec. 1, 2016

(54) Margin Ring and Method of Making Dental Crown Using the Margin Ring

(71) Applicant: Chan Qian Wang, Chagrin Fall, OH (US)

(72) Inventor: Chan Qian Wang, Chagrin Fall, OH (US)

(73) Assignee: Zuga Medical, Inc., Beachwood, OH (US)

(21) Appl. No.: 15/236,352

(22) Filed: Aug. 12, 2016

Related U.S. Application Data
(63) Continuation-in-part of application No. 13/138,726, filed on Sep. 22, 2011.
(60) Provisional application No. 62/203,907, filed on Aug. 12, 2015.

(51) Int. Cl. A61C 9/00; A61C 13/00; A61C 13/34; A61C 8/00

(52) U.S. Cl. CPC A61C 9/0033; A61C 8/0001; A61C 13/0004; A61C 13/34; A61C 8/0048; A61C 9/004

(57) ABSTRACT

The present invention provides a margin ring that can conforms to a dental abutment, and a method of using the margin ring to make a crown. The invention exhibits technical advantages such as a clearer impression; simplified operation such as elimination the step of packing a retraction cord; improved control over the fabrication of a crown; cost-effectiveness in terms of doctor chair time and lab cost; less usage of accessories; and fewer patient visits, among others.

### CROSS-REFERENCE TO RELATED U.S. APPLICATIONS

This application is a Continuation-in-Part of U.S. application Ser. No. 13/138,726 entitled “DENTAL RESTORATION SYSTEM AND METHOD THEREOF” filed on Sep. 22, 2011, which is a national stage application of PCT/US10/00837 filed on Mar. 22, 2010, which claims priority from U.S. Provisional Patent Application 61/162,333 filed on Mar. 22, 2009, which applications are hereby incorporated by reference in their entirety.

This application claims the benefits of U.S. Provisional application 62/203,907 filed on Aug. 12, 2015, the disclosure of which is incorporated herein by reference as if set forth in full.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention generally relates to a margin ring and methods of making dental crown using the margin ring. It finds particular application in conjunction with dental crowns, and will be described with particular reference thereto. However, it is to be appreciated that the present invention is also amenable to other dental prostheses such as veneers and bridges.

### BACKGROUND OF THE INVENTION

According to the American Association of Oral and Maxillofacial Surgeons, statistics show that 70% of adults aged 35 to 44 years in the U.S. have at least one missing tooth due to an accident, tooth decay, gum disease, or dental fracture. For a tooth that is damaged or lost, a dentist will design a crown to be secured on the remaining dentin or on an implant, and restore the function of that tooth. In designing a dental crown, it is critically important that the crown can accurately fit the oral environment, particularly, to fit the spatial configuration of the gum area around the tooth, for the purpose of an aesthetic appearance, as well as the hygiene in the interfacial region between the gum, the crown and the dentin or abutment/implant. This necessarily involves measurement or acquisition of three dimensional model of existing dental structures.

For example, a crown often extends below the gum line, and measurement of dental structures below the gum line needs to be carried out. However, a precise measurement below the gum line is difficult for the following reasons. First, the gum bleeds after prep. Second, the soft tissue pushes back and occupies the space between the gum and prepped tooth. Third, the abutment shoulder is lower than the gum level and is buried inside in the gum tissue.

Dental impressions are a traditional technique for providing a model of the mouth. Generally, a cast is produced from the impression and the cast then is used to produce the prosthesis. Such techniques suffer from inaccuracy due to multiple manual steps which can be technically demanding on the dentist as well as invasive and uncomfortable for the patient, especially if subgingival measurement is necessary. In attempt to acquire a clear impression, the dentist numbs the patient's jaw, and then use a thick cotton thread called retraction cord to push away the gum and to stop the gum bleeding. Usually, the dentist will soak the retraction cord in a hemostat liquid if the gum bleeds seriously. The procedure will take about 10 to 15 minutes to prepare the retraction cord and then pack it inside the gum. However, this time-consuming and labor-intensive procedure still can't always guarantee a clear impression, because the gum will push back and resume more or less to its original condition, after the retraction cord is removed.

For a traditional implant crown, the retraction cord cannot be packed between the gum and implant, because the operation would separate the gum and the implant, and destroy the connection between the periodontal tissue and implant, which may cause the bone recession later. If serious, the operation may lead to the failure of the implantation. As such, dentists generally use an open tray, a close tray, or an OS-Tray to transfer the soft tissue or hard tissue impression to the stone model.

However, the procedure is complicated and needs to use a lot of small accessories. For implant methods, dentists have to transfer the soft tissue impression by using the impression copings and implant analogs to the lab, and a lab technician will pick up the abutment for them and modify it in the lab, then send back for the patient to try. This procedure eliminates the doctor's role in making the implant crown directly by working in the patient's mouth; reduces the accuracy of the operation; increases the lab fee and accessory expenses,; burdens the patient with more office visits; and demands a lot more steps for the doctor to bring back the abutment to the right position.

More recently, digital scanning techniques have offered increased accuracy and detail of measurement. However, such techniques are only able to image, measure and model visible parts of the patient's mouth and generally do not provide imaging of subgingival areas. CT scanning can provide measurement of subgingival areas, however it does not provide soft tissue measurement.

The use of CAD/CAM in dentistry makes the traditional crown procedure much easier. An image sensor is used to take the image of the prepared tooth, and the crown will be made right away in the doctor's office. Alternatively, the image is sent to a lab, where the crown will be made and then sent back to the doctor's office. There is no impression step involved in such a procedure. The CAD/CAM can't be used to make a crown on implant, because (i) currently there is no direct abutment set up in the patient's mouth; (ii) the direct modification of an implant abutment is currently not available; and (iii) the part of the abutment which is covered by the gum cannot be detected by the CAM/CAD sensor. As such, dentists set up the impression copings on the implant, and take impression of the implant and surrounding soft tissue. Subsequently, the lab technician builds up the stone model, and uses this model to make the abutment and the crown.

Both existing physical impression methods and digital impression methods of measurement of subgingival areas usually include the step of physically separating the gingiva from the circumference of the tooth (or teeth) to be measured when the measurements are taken. As described above, this separation usually causes bleeding which needs to be stemmed or prevented before measurements can be made. The process of separation sometimes causes trauma to the gingiva, which can lead to inflammation and permanent damage to the gingiva.

Therefore, the dilemma is either to use damaging, painful, technically challenging methods to expose subgingival tooth areas (e.g., cord packing) for measurement, or to forgo subgingival measurements resulting in either ill-fitting prosthesis with unpleasing aesthetics where the border between the prosthesis and tooth structure is visible above the gum line. Advantageously, the present invention overcomes the dilemma by providing a dental prosthesis comprising a standardized subgingival portion and a process of fabricating the same. The present invention exhibits numerous technical merits such as a clearer impression; simplified operation such as elimination the step of packing a retraction cord; less injury such as gum bleeding and avoidance of the bone recession; improved control over the fabrication of a crown; cost-effectiveness in terms of doctor chair time and lab cost; less usage of accessories; and fewer patient visits, among others. For example, one or more of these merits will be particularly exhibited when the present invention is combined with the modifiable abutment as disclosed in the co-pending patent application with Ser. No. 12/255,471 filed by the same applicant. The combination will enable a dentist to directly modify the abutment in a patient's mouth, and use the present invention with a CAD/CAM system.

### SUMMARY OF THE INVENTION

One aspect of the present invention provides a margin ring having a lower section and an upper section, wherein the lower section consists of a bottom surface, an internal surface, an external surface and a top surface, wherein the upper section consists of pillars that extend perpendicular from the top surface of the lower section, wherein said pillars each has a top surface, an internal surface with a protrusion pointing inward that generates pressure when the pillar is pushed outward, an external surface with a protrusion pointing outward that has an embedment capability in a curable material, and wherein said pillars are separated by voids to enhance the pressure generation and the embedment capability of each pillar.

The margin ring may be used with a dental abutment, wherein the dental abutment includes a body and a shoulder, wherein the shoulder has a supporting surface for a dental crown, wherein the body is connectable to the dental crown, wherein the lower portion of the body immediately above the shoulder conforms with the internal surface of the margin ring, and the dental abutment shoulder's supporting surface conforms with the bottom surface of the margin ring, and body of the dental abutment conforms with the internal protrusion on the internal surface of the pillar of the margin ring such that pressure is placed by the margin ring pillar protrusion on the body of the abutment.

Another aspect of the invention provides a method of making a dental crown using the physical margin ring and the physical dental abutment. The method starts with a step of placing the margin ring around the abutment's lower portion inside a patient's mouth, so that the margin ring's bottom surface mates the shoulder's supporting surface, the margin ring's internal surface mates the lower portion's external surface, and the margin ring's external surface is surrounded by soft tissue. Subsequently, various steps may be taken to make the crown.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form in order to avoid unnecessarily obscuring the present invention. Other parts may be omitted or merely suggested.

FIG. 1 illustrates a margin ring in accordance with an exemplary embodiment of the present invention.

FIG. 2 schematically demonstrates a dental abutment in accordance with an exemplary embodiment of the present invention.

FIG. 3 shows the margin in FIG. 1 can have mating relationship with the dental abutment in FIG. 2 in accordance with an exemplary embodiment of the present invention.

FIG. 4 is a cross sectional view that schematically demonstrates the spatial relationship between a margin ring, a dental abutment, soft tissue and jaw bone in accordance with an exemplary embodiment of the present invention

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

In mathematics, a surface is a geometrical shape that resembles to a deformed plane. For example, a surface may be the boundary of a solid object in ordinary three-dimensional Euclidean space. Therefore, when surface (either physical or virtual) is mentioned in the present invention, unless otherwise specified, it is always related to a solid object (either physical or virtual) having at least that surface.

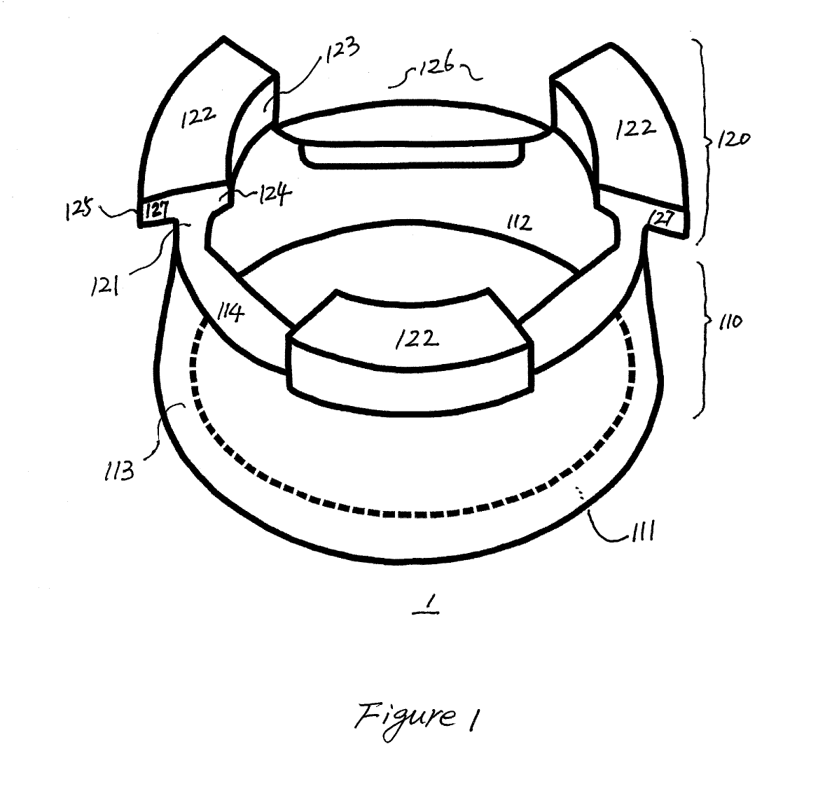

With reference to FIG. 1, margin ring 1 has a lower section 110 and an upper section 120. The lower section 110 consists of a bottom surface 111, an internal surface 112, an external surface 113 and a top surface 114. The upper section 120 consists of pillars 121 that extend perpendicular from the top surface 114 of the lower section 110. Pillars 121 each has a top surface 122, and an internal surface 123 with a first protrusion 124 pointing inward that generates pressure when the pillar 121 is pushed outward. Also, pillars 121 each has an external surface 125 with a second protrusion 127 pointing outward that has an embedment capability in a curable material. Pillars 121 are separated by voids 126 to enhance the pressure generation and the embedment capability of each pillar.

With reference to FIGS. 1 2 and 3, dental abutment 2 including a body 210 and a shoulder 220, Shoulder 220 has a supporting surface 221 for a dental crown (not shown). The body 210 is connectable to the dental crown (not shown). The lower portion 211 of the body 210 immediately above the shoulder 220 conforms to the internal surface 112 of the margin ring 1. Dental abutment shoulder 220′s supporting surface 221 conforms to the bottom surface 111 of the margin ring 1. Body 210 of the dental abutment 2 conforms to the protrusion 124 on the pillar 121 of the margin ring 1 such that pressure is placed by the margin ring pillar protrusion 124 on the body 210 of the abutment 2. The phrases “A conforms to B” and “A mates B” are interchangeable.

Margin ring 1 is an example of the so-called “shape determiner” in co-pending U.S. application Ser. No. 13/138,726. Margin ring 1 may be a regular or irregular ring directly surrounding or circling the apical (bottom) part (i.e. portion 211) of dental abutment 2. It may also be a regular or irregular C-shaped structure incompletely surrounding dental abutment 2.

Dental abutment 2 is an example of the so-called “crown base” in co-pending U.S. application Ser. No. 13/138,726. Dental abutment 2 may be a single piece with homogenous texture made of any suitable material such as metal, alloy, polymer, and composite material. Dental abutment 2 may be, for example, the dentin of a tooth under restoration, a ground down tooth, or an abutment with or without the portion of an implant that is on or above the surface of the jawbone where the implant sits. A common abutment is substantially cylindrical that is typically screwed into the endosseous implant, on top of which the crown can be affixed. In preferred embodiments, dental abutment 2 may be the modifiable abutment as described in the co-pending patent application with Ser. No. 12/255,471 filed by the same applicant, which is incorporated herein in its entirety.

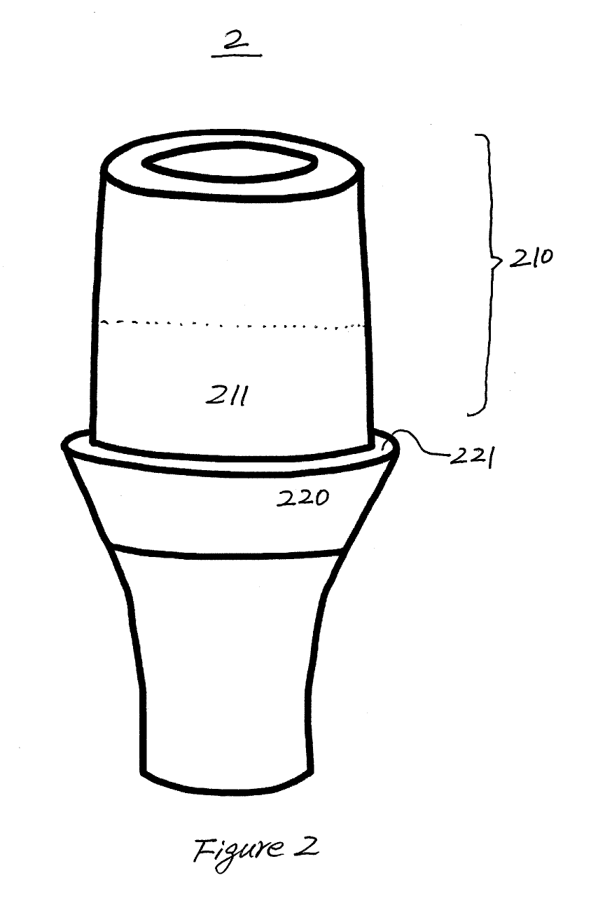

Shoulder 220 as shown in FIG. 2 is an example of the so-called “determiner stopper” in co-pending U.S. application Ser. No. 13/138,726. In various embodiments, shoulder 220 protects the nearby epithelial attachment against the pressure from margin ring 1. Any form of shoulder 220 may be used, for example, one or more protrusions, or a regular or irregular circular shoulder.

Margin ring 1 and dental abutment 2 may or may not be paired products and can be pre-determined regarding their shape, size and dimension etc. They can be pre-manufactured by mass production, and are commercially available from Zuga Medical Inc., 24400 Chagrin Blvd. Suite 250, Beachwood, Ohio 44122 (hereinafter “Zuga”).

A method of the present invention uses margin ring 1 and dental abutment 2 to make a dental crown, as will be explained in the following.

As generally known to a dentist, after certain time allowed for osteointegration of an implant, a healing cap is then removed from the implant. The nearby soft tissue should have grown around the healing cap but not over it so that it is easy to remove. Bone level implants are preferred when there is limited vertical space from the implant to the occlusal surface. Bone level implants have also shown less marginal bone loss when compared to tissue level implants after one year, allowing for better cosmetic result. The implant can have thread design for high stability, and higher amount of surface area, allowing dentists to establish better torque. The surface of the implant may be sand blasted, as sand blasting the implant will roughen its surface for maximized osteointegration. The implant may have a cylinder taper shape that is equipped with anti-rotation grooves, allowing for better torque and a higher chance of implant success.

Titanium implants available from Zuga have three diameters (3.5 mm, 4.3 mm and 5.0 mm) and four lengths (8 mm, 10 mm, 13 mm, and 15 mm) to cover all placement needs. A sealing cap is used with the implant and has three diameters adapted to implant sizes (3.5 mm, 4.3 mm and 5.0 mm).

The abutment 2 is placed on top of the implant, and a fixation screw is placed inside the abutment 2. The abutment is then secured to the implant with a screw adaptor. Abutment 2 may be a standard titanium abutment designed with a morse taper which helps prevent crestal bone loss. Zuga abutments may also have three diameters (corresponding to implant 3.5 mm, 4.3 mm and 5.0 mm) and two lengths (5.5 mm and 7.0 mm).

Platform switch is made possible with Zuga products. Zuga implants have a standardized platform which allows any implant to be cross matched with any abutment. This allows the proper abutment to fit on the proper implant regardless of situation. Using a smaller abutment on a bigger implant encourages better bone attachment and prevents initial peri-implant bone loss. Moreover, taper, anti-rotation hex and fixation screw can maximize the implant-abutment stability. The fixation screw connects the implant and abutment together for a tight, secure fit. Forces are directed from the crown to the implant which reduces stress on the Crestal bone. The taper cone creates a consistently smaller abutment implant contact.

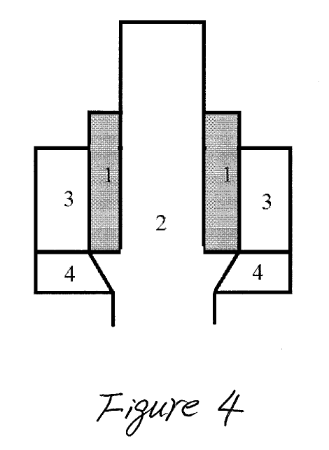

FIG. 4 illustrate that the margin ring 1 of matching width is placed around the abutment 2. More specifically, the margin ring 1 (e.g. the lower section 110) is placed around the abutment 2's portion 211 inside a patient's mouth, so that the margin ring 1's bottom surface 111 mates the shoulder's supporting surface 221, and the margin ring 1's internal surface 112 mates the portion 211's surface. The margin ring's external surface is surrounded by soft tissue 3, and the abutment 2 is adjacent to bone 4.

The margin ring helps to fit every crown to any abutment. The ring (through its surface 111) exactly conforms to (“mates”) and exactly represents the design and dimensions of any stops, such as abutment shoulder 220 (through its surface 221), a crown base shoulders, or the crestal jaw or other stop that prevents the margin ring from being seated any lower than optimal over the area of the implant and related structures. The ring carries some future information for the internal and external design of the crown, and it transports the margin information needed to make the perfect crown. The ring carries the shape information of the future interface between the crown and the gingiva. It also carries the information below the gingiva level, and the negative shape of the area between implant and abutment and crown base and the gingiva.

Margin ring 1 ensures that the gingiva does not collapse against the implant and/or abutment in a way that would detrimentally skew the information for the future internal and external apical design of the crown. Moreover, it eliminates the use of the impression coping, impression transfer, implant analog, and wax sleeve. By eliminating all the unnecessary restoration accessories, the margin ring helps the dentist save time and money for his or her practice. If an intra-oral modifiable abutment is used in association with the implant, the transmission of information that allows the crown to be made without the use of traditional information transferring parts such as copings, analogs and scan bodies.

The margin ring 1's external surface 113 is now surrounded by soft tissue 3. In preferred embodiments, margin ring 1 comprises a therapeutic and/or preventive medical agent such as a releasable hemostat agent for stopping the bleeding, for example, thrombin protein, kinases, chemicals, and vitamins. The surface of margin ring 1 may be loaded with the medical agent by way of for example, roughened surface or absorption with gauze, sponge, pledget, collagen, and poly-fibers. One of such margin ring may be commonly named as, for example, a hemostat margin ring, which combines the function of hemostat cap and retraction cord.

Zuga margin rings have three diameters (corresponding to implant 3.5 mm, 4.3 mm and 5.0 mm) and two heights (3 mm and 5 mm). The healing caps have three diameters (corresponding to implant 3.5 mm, 4.3 mm and 5.0 mm) and one height (5 mm). Zuga ring can be manufactured from plastic, titanium, silicone rubber, ceramic or other materials that ensures that the information for the future internal and external apical design of the crown is not lost in the restoration and crown manufacturing process.

In a preferred embodiment, the ring may have a sinusoidal interface, when used in conjunction with an abutment 2 with a sinusoidal wave shaped shoulder 220. The sinusoidal features on the ring and shoulder exactly mate each other. The ring carries the information for the future internal and external apical design of the crown. The trough of the sinusoidal wave on the ring generally orients distally so that the information carried for the future internal and external apical design of the crown can create an improved and more aesthetically pleasing interface between the crown and the gingiva. A sine wave or sinusoid is a mathematical curve that describes a smooth repetitive oscillation. In an embodiment, there are a front trough and a rear trough, a left crest and a right crest on the ring and on the shoulder, when they are placed in a patient's mouth. In another embodiment, there are a front crest and a rear crest, a left trough and a right trough on the ring and on the shoulder, when they are placed in a patient's mouth.

The step of taking a negative impression of the abutment 2, the margin ring 1 and surrounding soft tissue 21 can be accomplished by positioning within the mouth of the patient a shallow curved tray which contains a polymer material such as alginate, elastomer, hydrocolloid or a polyether. This polymer material is capable of being indented by dental abutment 2 as well as margin ring 1, and forming and retaining a stable impression. The impression material is initially in the form of a putty, slurry or thick paste which rapidly solidifies at ambient room temperature and pressure. The tray is inserted into the patient's mouth positioned generally horizontally, and the patient bites down on the tray, or the tray is pressed into contact with dental abutment 2 and ring 1, thus pressing them into the viscous semi-liquid mold impression material held by the tray. After a few minutes, the mold impression material solidifies into a rubber-like elastomeric state which has formed therein precise negative impressions of the intraoral environment around margin ring 1 and dental abutment 2.

Dental impression trays for use as described above are available in a variety of styles. One type of the tray has an accurately curved plan-view shape which is similar to the curved arrangement of teeth in the jaw. The curved arc length of the tray approximates that of about one half an upper or lower jaw and hence is referred to as a quadrant tray. A flat, paddle-like handle protruding horizontally outwards from one end of the tray is usually provided, to facilitate inserting and removing the tray from a patient's mouth. A typical quadrant tray has on one side thereof a curved trough for receiving impression mold material, may be used to make impressions of upper or lower jaw quadrants and is referred to as a standard quadrant or single-bite tray. A double side quadrant tray has been filled the impression material in both sides. When a patient gently bites down, the tray receives the impression. It also receives the bite information from the opposite occlusion which will help the doctor and lab technician to design the external shape of the dental crown.

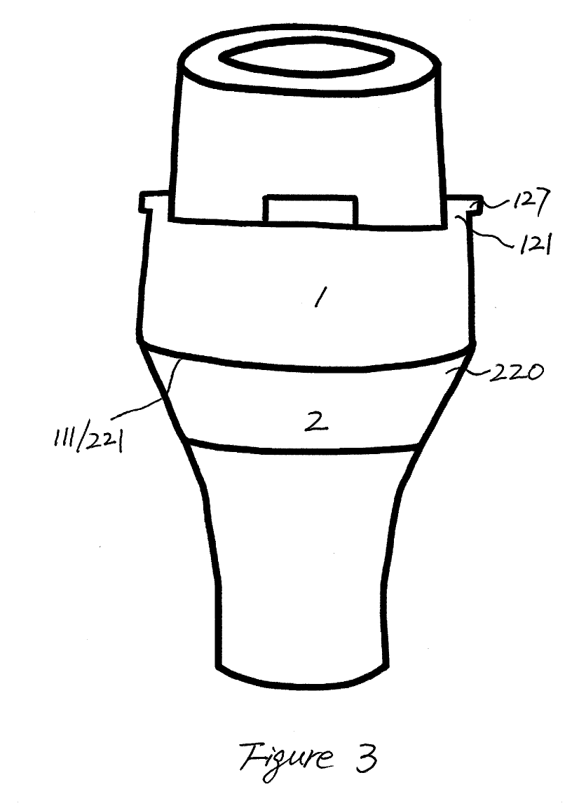

As the margin ring 1 is attached to the impression material, it goes with the impression material. The impression material and the margin ring 1 attached thereto are then taken out from the patient's mouth. The upper section 120 of the ring, particularly pillars 121 and protrusions 127 thereon, are designed to facilitate the attachment of the ring to the impression material. Other methods of such attaching is described in co-pending U.S. application Ser. No. 13/138,726. FIG. 3 in that application schematically illustrates a process of attaching a margin ring to an impression material, and removing both the ring and the hardened/cured impression material from the crown base. This form of ring may comprise one or more housing structures intended to accept the impression material. A dentist may press the material so that it contacts the upper surface of ring 1, and the material is forced to flow into the housing structures. After the impression material, including those flowed into the housing structures, is cured or hardened, the ring can be attached to the impression material. By the same token, margin ring such as a hemostat margin ring may be designed to have pin holders on the upper surface, and integrated with impression material when hardened.

After impressions of teeth have been made in the manner described above, and the mold impression material is solidified, the tray holding solidified mold impression material containing negative impressions is removed. The mold, typically referred to as an “impression” is then used to make positive replicas of the relevant oral environment.

The next two steps are pouring a stone model material into the negative impression to make a stone model. The margin ring 1 is attached to the stone model material. Then, the stone model is separated from the impression. Margin ring 1 remains attached to the stone model, and is detached from the impression material. Stone model material may be a semi-liquid molding material such as plaster, or die stone. After the die stone has solidified into a hard stone-like casting, or cast, the cast is removed from the impression. As the impression material is elastomeric, it can be readily peeled away from the model. The casting is then used to fabricate a wax model. In another embodiment, the ring is removed from the stone model, and then the stone model, with a clear representation of the space that was occupied by the margin ring, is subject to any follow-up procedures known to skilled person in the art, for example, scanning, wax modeling, and the like.

For example, the dentist may build a wax model of a dental crown based on the stone model and the margin ring. At this time, the margin ring 1 is being attached to the wax model. Next, the dentist separates the wax model from the stone model. Margin ring 1 remains attached to the wax model 28 and is detached from the stone model.

Finally, a dental crown is fabricated from the wax model and the margin ring 1 attached thereto. Wax model and margin ring 1 together function as a bigger wax model for making the dental crown, and the margin ring's internal surface 112, bottom surface 111 and external surface 113 are therefore transferred to the finished crown.

The crown is cemented on top of the abutment 2. Because the margin ring 1 has captured the crucial margin information for the dental lab to construct the crown, the crown fits the patient perfectly and comfortably. A dental crown may be selected from an implant crown, a regular crown, a bridge, and a Cerac Crown. The material used to make to the crown is preferably inert and non-toxic in an oral environment. The crown should have chemical durability in an oral environment, sufficient structural integrity to resist the forces of mastication, wear characteristics which are similar to natural human teeth, and have esthetic qualities, such as coloration similar to human teeth with a slightly translucent appearance.

The crown may comprise any material selected from porcelain, metal, metal alloy, ceramic material, glass-ceramic material, polymeric material, and any combination thereof. In a preferred embodiment of the present invention, the ceramic material is a translucent polycrystalline material, because the natural tooth enamel has a high translucency, whereas dentine has a lower translucency. A polycrystalline material has a multiplicity of randomly oriented crystals joined at grain boundaries. Preferably, the ceramic material is substantially nonporous to maintain a high degree of optical translucency. Translucency is the property of a specimen by which it transmits light diffusely without permitting a clear view of objects beyond the specimen and not in contact with it. A translucent material is an advantage because a crown, for example, formed from such a material effectively blends in with its surroundings and assumes the color of the underlying tooth and the teeth adjacent to it. This can provide improved aesthetics as compared to more opaque materials. In some embodiments, a dentist may need to color-match a crown with the color and shade of the dentition that surrounds the crown. In an embodiment, the ceramic material for the crown is an alpha aluminum oxide. Aluminum oxide is particularly desirable since its optical transmittance is substantially constant throughout the visible spectrum and it therefore does not change the color of light passing through.

In addition to the margin ring, the abutment, the implant, accessories and tools for this process are also available from Zuga to enable the implementation of the process as described above, including impression analog for all implants (3.5 mm, 4.3 mm and 5.0 mm), universal scan body, universal fixation screw, bone graft material for placing the implant, a motor, a handpiece, a ratchet, 3 tap drills (3.5 mm, 4.3 mm and 5.0 mm), 12 twist drills (D=3.5 mm, 4.3 mm and 5.0 mm times L=8 mm, 10 mm, 13 mm, and 15 mm), 3 gum punches (3.5 mm, 4.3 mm and 5.0 mm), one placement pin, one ratchet implant adaptor, one ratchet restoration adaptor, and one pilot drill. Regarding the motor, a controller can simplify the process of placing implants. Features of the controller include adjustable torque settings up to 50 ncm and programmable buttons to store common procedures. The handpiece may be a 20:1 contra angle handpiece that has an integrated titanium design, a small head for easier access, and that is ergonomically designed for practitioner's comfort.

A CAD/CAM system may be employed in the present invention to make the crown. 3D modeling is the basis for CAD/CAM. In 3D computer graphics, 3D modeling is the process of developing a mathematical representation of any three-dimensional surface of an object via specialized software. 3D model can be displayed as a two-dimensional image through a process called 3D rendering. The model can also be physically created using 3D printing devices.

In light of the process as described above, other methods of the invention can be readily appreciated. One of the methods for making a dental crown includes the following steps:

Step (i) is placing the physical margin ring around the abutment's portion 211 inside a patient's mouth, so that the margin ring's bottom surface 111 mates the shoulder's supporting surface 221, the margin ring's internal surface 112 mates the portion 211′s external surface, and the margin ring's external surface 113 is surrounded by soft tissue. The step can be executed in a similar way as described above, and will not be repeated here for conciseness.

Step (ii) is scanning the margin ring, the abutment, and the surrounding soft tissue to create an intraoral 3D digital model. This “digital impression” by 3D modeling is functionally similar to the impression and stone modeling. To obtain an intraoral 3D digital model, a dentist can use any known imaging systems, such as a digital scanning system. For example, a scanner may be positioned proximate to dental abutment 2, so that the distance between the scanner and dental abutment 2 is within the depth of focus of the optics of the scanner. A scanning system may capture a series of two-dimensional images containing surface information, and then generate an accurate three-dimensional computer model from the captured images. The surface configuration in three dimensions of space can be represented as a mathematical model, i.e., a virtual model, which can be displayed on any workstation or computer using software tools. The mathematical model can be viewed in any orientation in space, permitting detailed analysis of the surface. The virtual model can be transported from one computer to another computer anywhere in the world essentially instantaneously over communications links such as the Internet. The model can be replicated in a computer and thus shared and used by multiple users simultaneously.

The scanning system further includes at least one memory and one data processing unit, e.g., the central processing unit of a computer or a digital signal processor, which processes the images. Multiple processing units can be used to reduce the amount of time it takes to process the two-dimensional images, calculate three-dimensional coordinates for points in each image, and register frames of three-dimensional coordinates relative to each other to generate a complete virtual model. The processing unit and the memory can be located at a separate location, or be constructed in a single unit. A suitable cable may be used to connect the scanner device to a workstation to thereby supply the processing unit with scan data, and to receive commands (illumination commands, start/stop commands, etc.) from the workstation.

Like the wax modeling as described above, step (iii) is generating a first 3D digital model of the crown based on the intraoral 3D digital model using a CAD/CAM system. However, this model does not include the margin ring 3D data. Step (iv) compensates this missing data. That is to provide a 3D digital model of the margin ring to the CAD/CAM system. Next, in step (v), the first 3D digital model of the crown is combined with the 3D digital model of the margin ring to generate a second 3D digital model of the crown, which is a complete and accurate model of the crown. Finally, CAM is used to fabricate a dental crown from the second 3D digital model of the crown. As a result, the margin ring's internal surface, bottom surface and external surface are transferred to the finished crown.

While digital data processing prior to the fabrication of crown can be accomplished using known Computer-Aided Design (CAD) techniques, the fabrication per se can be accomplished using known Computer-Aided Manufacturing (CAM) techniques. CAD/CAM dentistry uses subtractive processes (such as CNC milling and turning) and additive processes (such as 3D printing) to produce the crown from 3D models. Milling is the machining process of using rotary cutters to remove material from a workpiece. With computer numerical control (CNC), milling machines can be equipped with automatic tool changers, tool magazines or carousels, CNC control, coolant systems, and enclosures. Crown can be manufactured with multitasking machines (MTMs) using any combination of milling and turning operations.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. A margin ring having a lower section and an upper section, wherein the lower section consists of a bottom surface, an internal surface, an external surface and a top surface, wherein the upper section consists of pillars that extend perpendicular from the top surface of the lower section, wherein said pillars each has a top surface, an internal surface with a protrusion pointing inward that generates pressure when the pillar is pushed outward, an external surface with a protrusion pointing outward that has an embedment capability in a curable material, and wherein said pillars are separated by voids to enhance the pressure generation and the embedment capability of each pillar.

2. The margin ring according to claim 1, which is combined with a dental abutment, wherein the dental abutment includes a body and a shoulder, wherein the shoulder has a supporting surface for a dental crown, wherein the body is connectable to the dental crown, wherein the lower portion of the body immediately above the shoulder conforms with the internal surface of the margin ring, and the dental abutment shoulder's supporting surface conforms with the bottom surface of the margin ring, and body of the dental abutment conforms with the internal protrusion on the internal surface of the pillar of the margin ring such that pressure is placed by the margin ring pillar protrusion on the body of the abutment.

3. A method of making a dental crown using the margin ring and the dental abutment of claim 2, comprising:
placing the margin ring around the abutment's lower portion inside a patient's mouth, so that the margin ring's bottom surface mates the shoulder's supporting surface, the margin ring's internal surface mates the lower portion's external surface, and the margin ring's external surface is surrounded by soft tissue.

4. The method according to claim 3, further comprising
taking a negative impression of the margin ring, the abutment, and the surrounding soft tissue with an impression material, wherein the margin ring is attached to the impression material; and
taking the impression material and the margin ring attached thereto out from the patient's mouth.

5. The method according to claim 4, further comprising
pouring a stone model material into the negative impression to make a stone model, wherein the margin ring is attached to the stone model material; and
separating the stone model from the impression material, wherein the margin ring remains attached to the stone model, and is detached from the impression material.

6. The method according to claim 5, further comprising
building a wax model of a dental crown based on the stone model and the margin ring, wherein the margin ring is being attached to the wax model; and
separating the wax model from the stone model, wherein the margin ring remains attached to the wax model and is detached from the stone model.

7. The method according to claim 6, further comprising
(8) fabricating a dental crown from the wax model and the margin ring attached thereto, wherein the wax model and the margin ring together function as a bigger wax model for making the dental crown, and whereby the margin ring's internal surface, bottom surface and external surface are transferred to the finished crown.

8. The method according to claim 4, further comprising
pouring a stone model material into the negative impression to make a stone model; and
separating the stone model from the impression material, wherein the margin ring is not attached to the stone model.

9. The method according to claim 10, further comprising scanning the stone model to generate a 3D digital model for a CAD/CAM process to make the dental crown.

10. The method according to claim 5, further comprising scanning the stone model to generate a 3D digital model for a CAD/CAM process to make the dental crown.

11. The method according to claim 3, further comprising
scanning the margin ring, the abutment, and the surrounding soft tissue to create an intraoral 3D digital model;
generating a first 3D digital model of the crown based on the intraoral 3D digital model using a CAD/CAM system;
providing a 3D digital model of the margin ring to the CAD/CAM system;
combining the first 3D digital model of the crown and the 3D digital model of the margin ring to generate a second 3D digital model of the crown; and
fabricating a dental crown from the second 3D digital model of the crown, whereby the margin ring's internal surface, bottom surface and external surface are transferred to the finished crown.
